(19) United States
(12) Patent Application Publication
(10) Pub. No.: US 2016/0255271 A1
(43) Pub. Date: Sep. 1, 2016

(54) INTERACTIVE SURVEILLANCE OVERLAY

(71) Applicant: International Business Machines Corporation, Armonk, NY (US)

(72) Inventors: James E. Bostick, Cedar Park, TX (US); John M. Ganci, JR., Cary, NC (US); Sarbajit K. Rakshit, KOLKATA (IN); Craig M. Trim, Sylmar, CA (US)

(21) Appl. No.: 14/633,207

(22) Filed: Feb. 27, 2015

(51) Int. Cl. H04N 5/232; G06K 9/00; G06T 7/00; H04N 7/18; G06T 11/60

(52) U.S. Cl. CPC H04N 5/23238; H04N 7/181; G06T 11/60; G06T 7/0042; G06K 9/00771; G06T 2207/30232; G06T 2207/20212

(57) ABSTRACT

An interactive surveillance overlay is provided. A processor receives surveillance data of an object within an incident area. A processor determines a movement of an object within the incident area based, at least in part, on the surveillance data. A processor extracts one or more images of the object based, at least in part, on the surveillance data. A processor generates at least one panoramic view of the incident area. A processor renders the one or more extracted images over the at least one panoramic view of the incident area.

### BACKGROUND OF THE INVENTION

The present invention relates generally to the field of surveillance, and more particularly to generating a panoramic view with images or video extracted from surveillance footage overlaid to the panoramic view.

Surveillance is the capturing of visual information for an area. Captured surveillance is used to monitor an area for activities and movement of objects with the area. The visual information is captured by a variety of devices (such as still or video cameras). With traditional surveillance systems, multiple devices are used to view an area from different angles. A user can individually view the captured information to determine movements of people or objects within the area. With this approach, the user views, individually, captured information from each device to determine overall movements of a person or object within the area.

### SUMMARY

Embodiments of the present invention provide a method, system, and program product to receive surveillance data of an object within an incident area; to determine a movement of an object within the incident area based, at least in part, on the surveillance data; to extract one or more images of the object based, at least in part, on the surveillance data; to generate at least one panoramic view of the incident area; and to render the one or more extracted images over the at least one panoramic view of the incident area.

### BRIEF DESCRIPTION OF THE SEVERAL VIEWS OF THE DRAWINGS

FIG. 1 is a functional block diagram illustrating an interactive surveillance environment, in accordance with an exemplary embodiment of the present invention.

FIG. 2 illustrates operational processes of providing an interactive surveillance overlay, on a computing device within the environment of FIG. 1, in accordance with an exemplary embodiment of the present invention.

FIG. 3 illustrates an example screenshot of the interactive surveillance overlay rendered by a visualization program, on a computing device within the environment of FIG. 1, in accordance with an exemplary embodiment of the present invention.

FIG. 4 depicts a block diagram of components of the computing device executing an interactive surveillance overlay, in accordance with an exemplary embodiment of the present invention.

### DETAILED DESCRIPTION

While solutions to monitoring surveillance systems are known, they require a user to view multiple video or image captures from different devices to determine the movements of a person or object. Embodiments of the present invention recognize that by extracting visual information captured from multiple devices and determining movement of objects contained in the visual information, a solution is provided that merges movements of objects captured by a surveillance system into a single viewable source. A panoramic view is generated for the area under surveillance. The panoramic view is a three-dimensional or first-person view of the area, where a user navigates within the view thereby having multiple viewpoints within the surveillance area. Objects are extracted from captured information of a surveillance system and then overlaid onto the panoramic view. When a user changes the perspective of the panoramic view, the extracted objects are overlaid and processed to match the location within the area, providing an interactive view of an area under surveillance. Embodiments of the present invention further recognize that, by predicting movements of an object captured by a surveillance system, a solution is provided to indicate probable movements of an object even though said movements were not captured. Probable movements are incorporated with the captured movements of an object to provide the user with a more detailed visualization of movements of an object.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

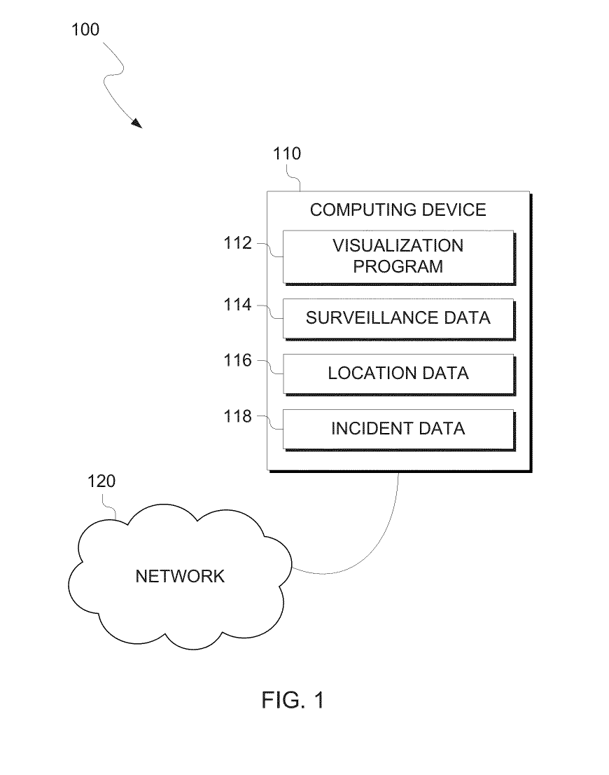

The present invention will now be described in detail with reference to the Figures. FIG. 1 is a functional block diagram illustrating an interactive surveillance environment, generally designated 100, in accordance with one embodiment of the present invention. Interactive surveillance environment 100 includes computing device 110 connected over network 120. Computing device 110 includes visualization program 112, surveillance data 114, location data 116 and incident data 118.

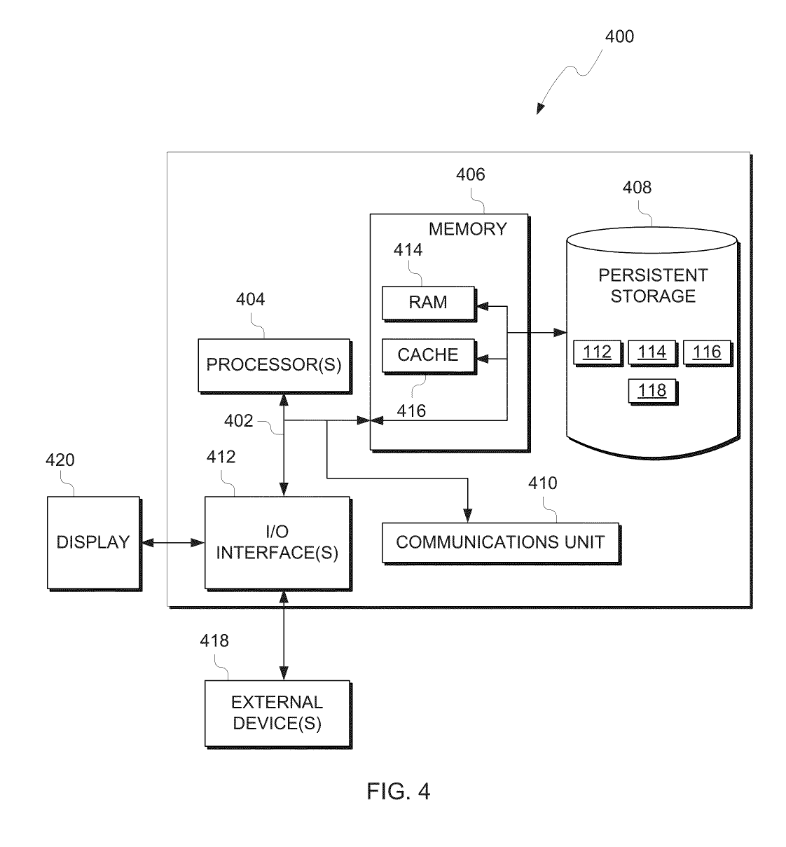

In various embodiments of the present invention, computing device 110 is a computing device that can be a standalone device, a server, a laptop computer, a tablet computer, a netbook computer, a personal computer (PC), or a desktop computer. In another embodiment, computing device 110 represents a computing system utilizing clustered computers and components to act as a single pool of seamless resources. In general, computing device 110 can be any computing device or a combination of devices with access to surveillance data 114, location data 116 and incident data 118 and is capable of executing visualization program 112. Computing device 110 may include internal and external hardware components, as depicted and described in further detail with respect to FIG. 4.

In this exemplary embodiment, visualization program 112, surveillance data 114, location data 116 and incident data 118 are stored on computing device 110. However, in other embodiments, visualization program 112, surveillance data 114, location data 116 and incident data 118 may be stored externally and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between computing device 110 and other devices of network 120 (not shown), in accordance with a desired embodiment of the present invention.

In some embodiments, visualization program 112 renders an interactive surveillance overlay onto a display, such as display 420 of FIG. 4, of computing device 110. In other embodiments, visualization program 112 creates a visualization of the interactive surveillance overlay and visualization program 112 sends the visualization, or instructions to create the visualization, to another computing device (not shown) connected to network 120. In various embodiments, visualization program 112 receives input from a user to create a visualization of an interactive surveillance overlay for an area under surveillance. Surveillance data 114 includes at least one video or image stream from a capture device such as, but not limited to, video cameras or still image cameras. In some embodiments, surveillance data 114 includes at least one of the location, direction or viewing angle of the capture device for stationary devices. Based on the at least one of location, direction or viewing angle, visualization program 112 creates a capture area of the capture device. In some embodiments, visualization program 112 receives from the user a capture area for a respective capture device. For capture devices that are not stationary (e.g., a device which rotates or pivots during capture), surveillance data 114 includes the area covered by the capture device when recording the video or image stream for the frames or still images as they are captured by the capture device. In an embodiment, surveillance data 114 includes at least one of the location, direction or viewing angle for each frame or image stored from the respective capture device. In various embodiments, surveillance data 114 includes one or more of a time or date at which the captured video or still images were recorded by the respective capture device.

In various embodiments, visualization program 112 receives a location or area to create a visualization of the interactive surveillance overlay. Based on the received location or area, visualization program 112 determines which capture areas of video or image streams of surveillance data 114 cover the received location or area. For example, visualization program 112 compares the received location or area to the capture areas of one or more capture devices. Based on an intersection of both the received location and the area with a capture area of a capture device, visualization program 112 includes the relevant information of the capture device with the interactive surveillance overlay. In other embodiments, visualization program 112 receives, from the user, surveillance data 114 to include in the interactive surveillance overlay. In various embodiments, visualization program 112 receives at least one of a time, a date, or a range of times or dates to create a visualization of the interactive surveillance overlay. Visualization program 112 compares the times or dates at which video or image streams of surveillance data 114 were captured to the time requested by a user. Visualization program 112 indicates that the video or image streams of surveillance data 114, with similar times and dates to the requested time or date, may have relevant information (e.g., video or images of an object to monitor).

In various embodiments, visualization program 112 creates a panoramic view of the requested location. Location data 116 includes one or more images or video of a location. Location data 116 includes at least one of a position or direction associated with the respective images or video. Based on the at least one position or direction of the images or frames of video, visualization program 112 creates a panoramic view of the location. For example, a user captures four images at a location, each directed to a cardinal direction (e.g., north, south, east and west). The users uploads the images to location data 116 in addition to the location and direction the image was captured. Visualization program 112 merges the photographs in a projection from the requested location such that a panoramic view from the requested location is created. The panoramic view provides a viewpoint that a user can change a perspective within the panoramic view. Visualization program 112 receives input from a user to tilt or rotate the viewpoint in order to view the location from a different perspective. In some embodiments, visualization program 112 creates a 360° view of a location. In such a view, the user can rotate the panoramic view a full 360°, viewing the location in from a first-person perspective from the viewpoint. In some embodiments, location data 116 includes groups of images at different points within the requested location. Visualization program 112 creates multiple panoramic views to provide the user the ability to move to the different points within the location in to view different panoramic views in a three-dimensional or first-person view. Visualization program 112 provides the user with the ability to tilt, rotate and pan the view within the three-dimensional space, such that multiple viewing angles within the different views are provided to the user. In other embodiments, visualization program 112 receives or downloads a panoramic view for another device (not shown) connected to network 120.

In various embodiments, visualization program 112 receives from a user information regarding an incident that a user requests to create an interactive surveillance overlay for analysis. Visualization program 112 receives information such as, but not limited to, a time of the incident, location of the incident, additional points of interest of the incident, or types of objects involved in the incident. Visualization program 112 stores the received information regarding the incident in incident data 118. Visualization program 112 determines relevant surveillance data 114 and location data 116 to create the interactive surveillance overlay. Based on the location of the incident, visualization program 112 determines relevant surveillance data 114 with coverage areas that match the location of the incident. Based on the time of the incident, visualization program 112 determines relevant surveillance data 114 that was captured at the time of the incident. In some embodiments, visualization program 112 determines relevant surveillance data 114 and location data 116 for additional times or locations as indicated by incident data 118.

In various embodiments, visualization program 112 determines relevant objects of surveillance data 114 to extract images or video of the object from surveillance data 114. In some embodiments, visualization program 112 presents to the user relevant surveillance data 114 to a user. Visualization program 112 receives input from the user regarding one or more objects captured in surveillance data 114 to extract and used in the interactive surveillance overlay. For example, a user selects an object from a captured image or video stream of surveillance data 114 to extract images and movement of the object from relevant captured image or video stream of surveillance data 114. In some embodiments, visualization program 112 receives an image or other visual information regarding the object to be extracted from surveillance data 116 from a user. Visualization program 112 compares the received image to video or images stored in surveillance data 114. Visualization program 112 determines matching surveillance data 114 containing the objects similar to the received image.

In various embodiments, visualization program 112 performs image processing to determine the position of an object within a frame or image of surveillance data 114 relative to area under surveillance. Once an object is determined to be present in one or more frames or images of surveillance data 114, visualization program 112 determines the location of the object within each frame or image. For example, visualization program 112 determines the presence of known objects (e.g, static objects such as buildings or landmarks) and compares the size and scale of the matched object to the known object. Based on the size and location of the known objects and the size of the matched object in surveillance data 114, visualization program 112 determines the distance of the matched object relative to the known object. In various embodiments, visualization program 112 extracts an image of the matched object from each frame or image of surveillance data 114. Visualization program 112 determines that an object in surveillance data 114 matches a requested object. For each frame or image, visualization program 112 extracts the object from surveillance data 114. For example, visualization program 112 determines a section of the frame or image containing the matched object. Visualization program 112 determines the parts of the section that are part of the background and removes the surrounding information, thereby leaving only the matched object in the extracted image.

In various embodiments, visualization program 112 determines captured movements of one or more object captured in surveillance data 114. Visualization program 112 determines the movement of an object within the area of the incident. Based on the capture area and the position or direction of a capture device, visualization program 112 determines the movements of the one or more objects within the incident area. In some embodiments, visualization program 112 extract images or video of the object as stored in surveillance data 114. For example, as an object moves through the incident area, visualization program 112 extracts images or video corresponding to the time the object is located within the incident area.

In some embodiments, visualization program 112 determines probable movements of an object within the incident area. For example, an object moves from the coverage area of one video stream of a capture device to another coverage area of different video stream of another capture device. During the transition between coverage areas, surveillance data 114 of the object was not captured. In such embodiments, visualization program 112 determines the probable movements of the object when surveillance data 114 for a given time is not present. Based on the previous movements of the object captured in surveillance data 114 or subsequent movements of the object captured in surveillance data 114, visualization program 112 determines probable movements of the object. Visualization program 112 compares the captured movements of the object to determine a path of movement the object undertook when the object was not captured in surveillance data 114. In some embodiments, visualization program 112 determines probable movements based on incident data 118 in addition to surveillance data 114. For example, incident data 118 includes a known location of the object prior to video or images of the object are stored in surveillance data 114. As another example, incident data 118 includes a point of interest regarding the incident such as a location where an event occurred. In other embodiments, incident data 118 includes multiple points of interest or known locations of the object within the incident area. In some embodiments, visualization program 112 determines a probable movement of the object from at least two of the known locations in incident data 118, points of interest in incident data 118 and the location determined from surveillance data 114. In various embodiments, visualization program 112 extracts images from the most recent images or video streams to use as extracted images of the object for probable movements.

In various embodiments, visualization program 112 generates an overlay including both the captured and probable movements of an object and the respective extracted images of the captured and probable movements from surveillance data 114. Visualization program 112 renders the overlay on top of the panoramic image of the incident area. Visualization program 112 generates a render of the overlay based on a current perspective of the panoramic image as currently provided to the user. Based on the viewing angle of the current view of the incident area, visualization program 112 determines the location of the extracted object within the current perspective of the panoramic view. Visualization program 112 performs image processing (e.g., tilt, pan, rotate, skew or scale) to the extracted images to match the current perspective of the panoramic view. For example, a video stream of surveillance data 114 is captured at a further distance than the current perspective of the panoramic view. Visualization program 112 increases the scale of the extracted image to match the closer viewing point of the panoramic view. Furthermore, as the user changes the perspective within the panoramic view, visualization program 112 performs image processing to update the rendering of the extracted images to reflect the change in perspective.

In various embodiments, visualization program 112 provides a timeline and respective controls to the user to render the movements of the extracted object onto the overlay. For example, visualization program 112 provides a play and pause function as part of the overlay. When play is activated, visualization program 112 renders the movements of the object on the overlay. During the playing of movements, visualization program 112 renders the location of the extracted images within the panoramic view using the captured or probable movements of the object. Visualization program 112 changes the position of extracted images of the object in relation to the current perspective of the panoramic view to match the movements of the object. In some embodiments, visualization program 112 provides multiple panoramic views to the user. As a user moves between panoramic views, visualization program 112 updates the overlay to correspond to the change in viewing perspective.

In various embodiments, visualization program 112 renders a map of the incident area. The map includes both captured and probable movements of object and landmarks of the incident area (e.g., streets or buildings). In some embodiments, visualization program 112 provides various panoramic views. When a user selects a location of the map, visualization program 112 selects the closest panoramic view. Visualization program 112 renders the selected panoramic view in addition to extracted images of the object relative to the selected panoramic view.

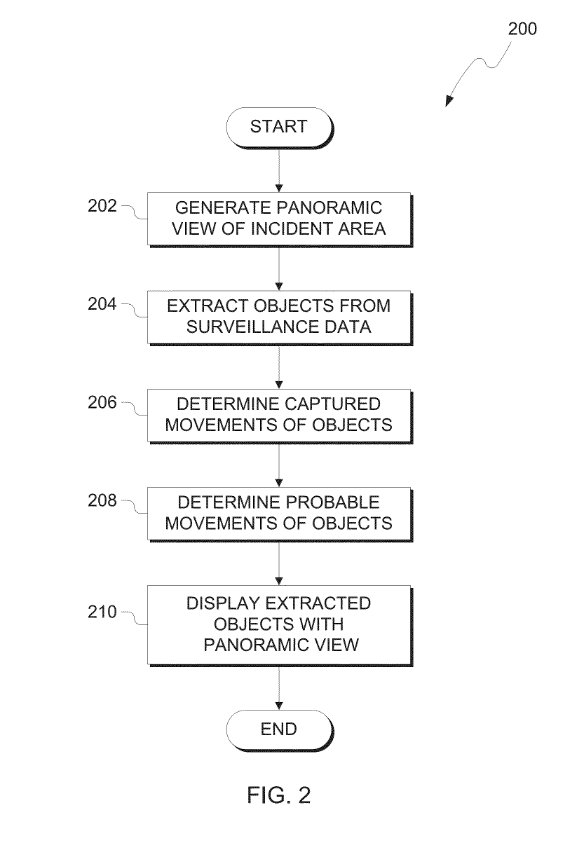

FIG. 2 is a flowchart illustrating operational processes, generally designated 200, of visualization program 112 for generating an interactive surveillance overlay, on computing device 110 within the environment of FIG. 1, in accordance with an exemplary embodiment of the present invention.

In process 202, visualization program 112 generates a panoramic view of an incident area. Visualization program 112 retrieves images taken of the incident area stored in location data 116. In some embodiments, a direction and position at which an image was captured is associated with each image. In other embodiments, visualization program 112 receives from a user the direction and position at which each image was captured. Based on the positions and directions of the captured images, visualization program 112 merges the images to create a panoramic view of the incident area. In some embodiments, another program (not shown) creates a panoramic view or the panoramic view is pre-existing. In embodiments where the panoramic view pre-exists, visualization program 112 receives a link or file containing the panoramic view from a user.

In process 204, visualization program 112 extracts objects from surveillance data 114. In some embodiments, visualization program 112 retrieves image data or other indicia of describing an object from incident data. Visualization program 112 matches the incident describing an object to one or more image or video streams from surveillance data 114. If an object in surveillance data 114 matches an object to be monitored as stored in incident data, then visualization program 112 extracts images of the object from surveillance data 114. Visualization program 112 associates a time and location within the incident area that the extracted images correspond to the captured surveillance data. In other embodiments, visualization program 112 receives from a user an indication of an object of one or more images or frames of surveillance data to extract from surveillance data 114. Visualization program 112 determines if the object is present in other image or video or streams of surveillance data 114. If the object is found in the streams, visualization program 112 extracts images of the matching object in addition to the time and location within the incident area the extraction from surveillance data 114 occurred.

In process 206, visualization program 112 determines captured movements of the extracted objects of process 204. Visualization program 112 analyzes a video or image stream containing the extracted object, as stored in surveillance data 114, to determine the movement of the object within the device's capture area and during the time that the object was captured by said streams. A capture device is associated with at least one of a location, position or direction. Visualization program 112 determines the position of an extracted object within the capture area by comparing the extracted objects position relative to other objects contained in the stream. The determined position includes the object's place or location within the surveillance area. In some embodiments, the determined position includes a direction the object is facing. For each image or frame of the stream, visualization program 112 determines a difference in movement of the extracted object compared to other captured images or frames of the stream. For example, a difference in movement includes a change in position of the extracted object, a change in rotation of the extracted object, and speed of the extracted object. Visualization program 112 compiles all the movements of the extracted object between frames or images and creates captured movement for the extracted object, as captured by a device. In some embodiments, more than one capture device for a given time frame captures movement of an object. In such embodiments, visualization program 112 compares the determined captured movements for each device. Based on the comparison, visualization program 112 merges the captured movements from the more than one capture devices. For example, visualization program 112 determines a first position of an extracted object at a certain time from video or images of a first capture device. Visualization program 112 determines a second position of an extracted object at same or similar time from video or images of a second capture device. The first position places the extracted object some distance away from the second position. Visualization program 112 merges the first and second positions to create a third position that is in between both the first and second positions. Visualization program 112 uses the third position for the position of the extracted object a given time frame.

In process 208, visualization program 112 determines probable movements of the extracted objects of process 204. In some instances, not all movements of an object are captured by a capture device covering the incident area. In such cases, visualization program 112 determines the probable movements of extracted objects. For example, an object is captured by a capture device for a given amount of time and then moves outside the capture area of the capture device. Sometime later, the object enters a capture area of another device. Visualization program 112 determines the movements of the object during this lapse in time when the object is not captured by any device whose stream is not stored in surveillance data 114. Visualization program 112 determines the position of the object as it leaves the first capture area and the position of the object as the object enters the second capture area.

In some embodiments, visualization program 112 determines a straight-line path between both entry and exit points to be the probable movements of the object. In other embodiments, visualization program 112 determines the probable movements using a pathing algorithm. For example, visualization program 112 determines the location of other objects in the incident area. The pathing algorithm will determine a path that avoids the other objects of the incident area. As another example, a capture device captures a still image at a set interval (e.g., every five seconds). As such, even though an object has not left the capture area, there are still movements of the object that were not captured by the capture device. In such cases, visualization program 112 determines probable movements of the object between images of the capture device. Based on the location of the object in one image and the location of the object in another image, visualization program 112 determines probable movements of the object for the time in between when the images where captured.

In some embodiments, visualization program 112 utilizes additional information describing an incident (as discussed throughout regarding incident data 118) to determine probable movements of an object. Visualization program 112 receives from a user a time and location of an object prior to the object entering a capture area of a capture device. Visualization program 112 determines probable movements of the object prior to the determined captured movements. Furthermore, visualization program 112 receives from a user a time and location of an object between captured movements of different capture areas. As such, visualization program 112 includes the received time and location into the determination of the probable movements between capture areas, in addition to the exit time and location from one capture area and the entry time and location into another capture area.

In process 210, visualization program 112 displays the extracted images with the panoramic view. Based on the current perspective of the panoramic view, visualization program 112 performs image processing to the extract images of the object to match the location of the object within the panoramic view. For example, visualization program 112 scales an image to match the distance from the perspective of the panoramic view such that the object appears to be the same size as it would from said perspective. As another example, if the perspective is rotated, visualization program 112 skews the image of the object to match the change in perspective. In some embodiments, visualization program 112 provides a timeline or player controls to a user. Visualization program 112 receives from the user input to view the movements (both captured and probable) of the object over time. Visualization program 112 receives from the user commands to pause, select different points of time within the timeline and resume the movements of the objects at anytime. During the playback of the objects movements, visualization program 112 receives commands to change the perspective of the panoramic view (e.g., rotating, panning, moving the perspective within the incident area). In response to the change in perspective, visualization program 112 updates both the panoramic view and the extracted images of objects currently displayed within the updated view to match the current perspective.

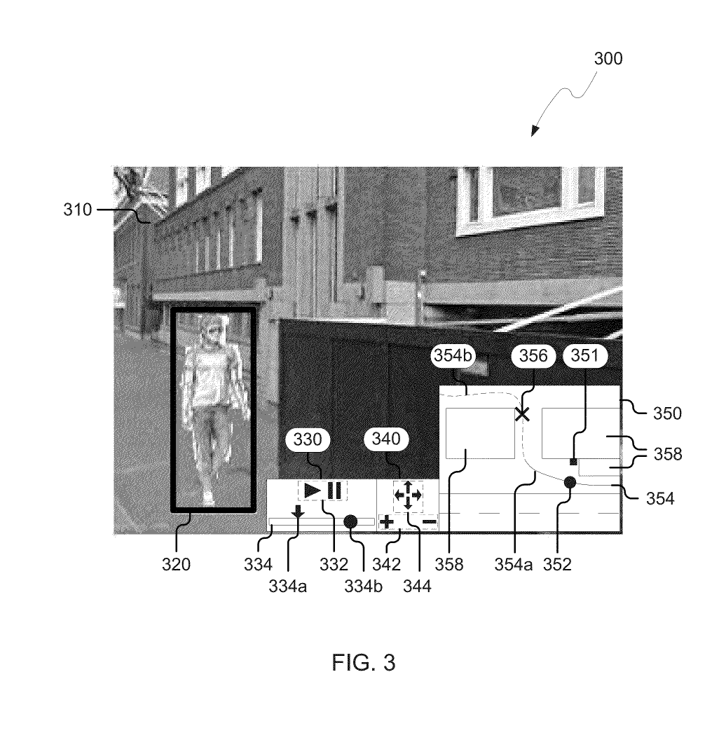

FIG. 3 illustrates an example screenshot of interactive surveillance overlay, 300, rendered by visualization program 112, on computing device 110 within the environment of FIG. 1, in accordance with an exemplary embodiment of the present invention.

In various embodiments, interactive surveillance overlay 300 includes panoramic view 310, extracted image 320, player controls 330, viewpoint controls 340, and incident map 350. Visualization program 112 renders a panoramic view 310 based on the current viewpoint within the incident area. Based on images stored in location data 116, visualization program 112 creates panoramic view 310. Visualization program 112 overlays extracted image 320 onto panoramic view 310. Visualization program 112 generates extracted image 320 based on the current viewpoint of panoramic view 310 and the time selected by player controls 330. Based on the viewpoint and selected time, visualization program 112 selects an extracted image from surveillance data 114 corresponding to the object's location and image within surveillance data 114.

In various embodiments, interactive surveillance overlay 300 includes player controls 330 to a user to select a time with a given time frame corresponding to an objects movements within an incident area. Visualization program 112 provides player action controls 332 to a user. Player action controls 332 includes a play and pause functionality. When a user activates the play function, visualization program 112 moves the location of extracted image 320 to correspond to the movements of the object within the incident area at a given time. In some embodiments, visualization program 112 updates extracted image 320 with an extracted image from surveillance data 114 of the object corresponding to the time that is currently being rendered. In various embodiments, when a user activates the pause function, visualization program 112 stops the movements of extracted image 320 within panoramic view 310.

In some embodiments, interactive surveillance overlay 300 includes incident timeline 334. Incident timeline 334 includes marker 334a and timeline position 334b. Timeline position 334b corresponds to the current time rendered by visualization program 112. When the play function of player action controls 332 is selected, visualization program 112 moves timeline position 334b to correspond to the current time being rendered. Furthermore, visualization program 112 receives, from a user, a selection along timeline 334. In response to the selection, visualization program 112 moves timeline position 334b to the corresponding time within incident timeline 334. In addition, visualization program 112 updates the position of extracted image 320. In some embodiments, visualization program 112 updates the extracted image from surveillance data 114 corresponding to the time the image was captured and the selected time in timeline position 334b. In some embodiments, incident timeline 334 includes marker 334a. Marker 334a indicates events or other times of interest of the object through the incident area. In this example screenshot, marker 334a corresponds to event 356 displayed in incident map 350. Markers, such as marker 334a, provides the user reference points within incident timeline 334 to select and compare to an object's movements within the incident area.

In various embodiments, interactive surveillance overlay 300 includes viewpoints controls 340 to receive input from a user regarding a desired viewpoint within panoramic view 310. Viewpoint controls 340 include zoom controls 342 and movement controls 344. Visualization program 112 provides zoom controls 342 to a user, such that the user can zoom in or out the current panoramic view 310. In response to the selected zoom controls 342, visualization program 112 updates panoramic view 310 by zooming either in or out. Furthermore, visualization program 112 scales extracted image 320 to match the change in zoom, such that the height and width of the extracted image 320 corresponds with the updated perspective of the object within panoramic view 310. Visualization program 112 provides movement controls 344 to a user, such that the user can select a new position within the incident area. Based on the current viewpoint and the selected movement, visualization program 112 creates a new panoramic view 310 based on the new position. In addition to updating panoramic view 310, visualization program 320 moves extracted image 320 to the corresponding location within the incident area and the updated viewpoint.

In various embodiments, interactive surveillance overlay 300 includes incident map 350 to display the surrounding incident area. Incident map 350 includes capture device indicator 351, monitored object indicator 352, movement path 354, point of interest 356, and known objects 358. Capture device indicator 351 indicates the location of a capture device which captured video or images is stored in surveillance data 114. In some embodiments, visualization program 112 provides an additional indication that a capture device is being used to extract images of the monitored object (e.g., highlighting or changing the color of capture device indicator 351). In other embodiments, when a monitored object is determined by visualization program 112 to be within in a capture area of a capture device, visualization program 112 provides an additional indication that a capture device has relevant surveillance data 114 of the monitored object (e.g., highlighting or changing the color of capture device indicator 351). Additionally, the user may select the capture device indicator 351 to view the relevant surveillance data 114 when visualization program 112 displays additional indications.

In various embodiments, monitored object indicator 352 indicates the location of a monitored object within the incident area for the given time interactive surveillance overlay 300 produces a rendering (e.g., a time selected on timeline 334). As time progresses and extracted image 320 is moved over panoramic view 310, monitored object indicator 352 reflects the monitored object's position within incident map 350. In various embodiments, movement path 354 indicates the monitored objects movement within the incident area on incident map 350. Movement path 354 includes captured movement path 354a and probable movement path 354b. Captured movement path includes movements of the object that were captured by a capture device. Probable movement path 354b includes movements of the monitored object that were no captured by a capture device (e.g., movements determined in process 208 of FIG. 2 by visualization program 112). In various embodiments, point of interest 356 include positions of events as stored in incident data 118. Points of interests may include, but are not limited to, known positions of the object not captured by a capture device or locations of events included in the incident. In various embodiments, known objects 358 include objects of the surrounding incident area. Known objects 358 may include, but are not limited to, buildings or other landmarks, static structures or objects, or any object of the surrounding incident area that is not being monitored. In some embodiments, known objects 358 may include objects not currently present in panoramic view 310 but where, at the time of the incident, present in the incident area.

FIG. 4 depicts a block diagram, 400, of components of computing device 110, in accordance with an illustrative embodiment of the present invention. It should be appreciated that FIG. 4 provides only an illustration of one implementation and does not imply any 6limitations with regard to the environments in which different embodiments may be implemented. Many modifications to the depicted environment may be made.

Computing device 110 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Visualization program 112, surveillance data 114, location data 116 and incident data 118 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of network 120. In these examples, communications unit 410 includes one or more network interface cards. Communications unit 410 may provide communications through the use of either or both physical and wireless communications links. Visualization program 112, surveillance data 114, location data 116 and incident data 118 may be downloaded to persistent storage 408 through communications unit 410.

I/O interface(s) 412 allows for input and output of data with other devices that may be connected to computing device 110. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., visualization program 112, surveillance data 114, location data 116 and incident data 118, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) “Smalltalk” and the like may be subject to trademark rights in various jurisdictions throughout the world and are used here only in reference to the products or services properly denominated by the marks to the extent that such trademark rights may exist.

What is claimed is:

1. A method of generating an interactive surveillance overlay, the method comprising:
receiving, by one or more processors, surveillance data of an object within an incident area;
determining, by the one or more processors, a movement of an object within the incident area based, at least in part, on the surveillance data;
extracting, by the one or more processors, one or more images of the object based, at least in part, on the surveillance data;
generating, by the one or more processors, at least one panoramic view of the incident area; and
rendering, by the one or more processors, the one or more extracted images over the at least one panoramic view of the incident area.

2. The method of claim 1, the method further comprising:
receiving, by the one or more processors, a change in a perspective of the at least one panoramic view; and
updating, by the one or more processors, the rendering of the one or more extracted images, in response to the change of perspective.

3. The method of claim 1, the method further comprising:
rendering, by the one or more processors, a map of the incident area, wherein the map includes the movement of the object within the incident area.

4. The method of claim 3, wherein the movement of the object within the incident area includes one or more of: (i) captured movements of the object, and (ii) probable movements of the object.

5. The method of claim 4, wherein the probable movements of the object are based, at least in part, on a path between at least two locations.

6. The method of claim 5, wherein the at least two locations comprise: (i) a first point from an area covered from a first capture device and (ii) a second point from an area covered from a second capture device.

7. The method of claim 5, wherein the at least two locations comprise: (i) a location of an incident and (ii) a point from an area covered from a capture device.

8. A computer program product for generating an interactive surveillance overlay, the computer program product comprising:
one or more computer-readable storage media and program instructions stored on the one or more computer-readable storage media, the program instructions comprising:
program instructions to receive surveillance data of an object within an incident area;
program instructions to determine a movement of an object within the incident area based, at least in part, on the surveillance data;
program instructions to extract one or more images of the object based, at least in part, on the surveillance data;
program instructions to generate at least one panoramic view of the incident area; and
program instructions to render the one or more extracted images over the at least one panoramic view of the incident area.

9. The computer program product of claim 8, the program instructions further comprising:
program instructions to receive a change in a perspective of the at least one panoramic view; and
program instructions to update the rendering of the one or more extracted images, in response to the change of perspective.

10. The computer program product of claim 8, the program instructions further comprising:
program instructions to render a map of the incident area, wherein the map includes the movement of the object within the incident area.

11. The computer program product of claim 10, wherein the movement of the object within the incident area includes one or more of: (i) captured movements of the object, and (ii) probable movements of the object.

12. The computer program product of claim 11, wherein the probable movements of the object are based, at least in part, on a path between at least two locations.

13. The computer program product of claim 12, wherein the at least two locations comprise: (i) a first point from an area covered from a first capture device and (ii) a second point from an area covered from a second capture device.

14. The computer program product of claim 12, wherein the at least two locations comprise: (i) a location of an incident and (ii) a point from an area covered from a capture device.

15. A computer system for generating an interactive surveillance overlay, the computer system comprising:
one or more computer processors;
one or more computer readable storage media; and
program instructions stored on the computer readable storage media for execution by at least one of the one or more processors, the program instructions comprising:
program instructions to receive surveillance data of an object within an incident area;
program instructions to determine a movement of an object within the incident area based, at least in part, on the surveillance data;
program instructions to extract one or more images of the object based, at least in part, on the surveillance data;
program instructions to generate at least one panoramic view of the incident area; and
program instructions to render the one or more extracted images over the at least one panoramic view of the incident area.

16. The computer system of claim 15, the program instructions further comprising:
program instructions to receive a change in a perspective of the at least one panoramic view; and
program instructions to update the rendering of the one or more extracted images, in response to the change of perspective.

17. The computer system of claim 15, the program instructions further comprising:
program instructions to render a map of the incident area, wherein the map includes the movement of the object within the incident area.

18. The computer system of claim 17, wherein the movement of the object within the incident area includes one or more of: (i) captured movements of the object, and (ii) probable movements of the object.

19. The computer system of claim 18, wherein the probable movements of the object are based, at least in part, on a path between at least two locations.

20. The computer system of claim 19, wherein the at least two locations comprise: (i) a first point from an area covered from a first capture device and (ii) a second point from an area covered from a second capture device.
